(19) United States
(12) Patent Application Publication
(10) Pub. No.: US 2008/0256747 A1
(43) Pub. Date: Oct. 23, 2008

(54) Hinge device of a foldable chair

(76) Inventors: Hsien-Wen Chang, Taipei (TW); Shek-Hing Simon Yu, Hong Kong (CN)

Correspondence Address: TROXELL LAW OFFICE PLLC, 5205 LEESBURG PIKE, SUITE 1404, FALLS CHURCH, VA, 22041, US

(21) Appl. No.: 11/785,598

(22) Filed: Apr. 19, 2007

(51) Int. Cl. E05D 7/06

(52) U.S. Cl. 16/239

(57) ABSTRACT

A hinge device of a foldable chair. The foldable chair includes a front tube, a middle tube, a rear tube and a foot stand. Three-way hinges each including a first pivoting portion, a second pivoting portion and a third pivoting portion connect the front tube, the middle tube, the rear tube and the foot stands together. The characteristic lies in that the third pivoting portion is shifted from a straight line connecting the first pivoting portion to the second pivoting portion so that the third pivoting portion and the first and second pivoting portions are disposed alternately and all the pivoting portions after being folded form a right-angle arranged pattern. The foot stand is folded on the inner side of the middle tube and arranged in parallel to inner and outer portions of the middle tube.

### BACKGROUND OF THE INVENTION

(1) Field of the Invention

The invention relates to a hinge structure of a foldable chair, and more particularly to a hinge device of a foldable chair capable of effectively reducing the volume and the thickness of the foldable chair after being folded so that the folded chair cannot occupy too much space as compared with the prior art.

(2) Description of the Prior Art

A foldable chair is a chair that may be folded. Due to the foldable design, the chair can be folded after being used or when not being used so that the volume of the chair is reduced to facilitate the hoarding and prevent the chair from occupying too much space. As shown in FIG. 1, a hinge is used in a typical foldable chair to achieve the foldable effect. The hinge 60 includes a first pivoting portion 61, a second pivoting portion 62 and a third pivoting portion 63. The first pivoting portion 61 is combined and positioned with the second pivoting portion 62 and the third pivoting portion 63 through pins 611 so that all pivoting portions after being folded form a straight line, as shown in FIG. 2, and can be freely spread out or folded.

The foldable chair occupies the smaller space when it is being stored, transported and placed in the warehouse to prevent the space from being wasted and can effectively enable the space to be optimized in a more efficient manner in the plant or the warehouse. Under the long term consideration of the economic effectiveness, however, if a foldable chair has a smaller volume after being folded can be provided, the rent for the plant and warehouse can be reduced, and the freightage of the container can be reduced. Thus, the loading of the manufacturer can be greatly reduced because the processing can be facilitated and the customer likes the product much more so that the foldable chair has the higher competition ability.

In view of this, the prevent inventor tries to seek for the solution by way of testing and manufacturing a novel hinge device of the foldable chair so that the overall volume of the folded chair can be reduced and the chair can be easily stored.

### SUMMARY OF THE INVENTION

It is therefore an object of the invention to provide a hinge device of a foldable chair capable of effectively reducing the volume and the thickness of the foldable chair after being folded so that the folded chair cannot occupy too much space as compared with the prior art.

Another object of the invention is to provide a hinge device of a foldable chair, wherein a lot of the foldable chairs can be transported and stored in the warehouse and the space utilization of the container, the warehouse or the plant may be optimized. Thus, more foldable chairs can be placed in the same space for the manufacturer when the chairs are being transported and placed in the warehouse, or the same number of chairs can be placed but more redundant space that can be used may be obtained. Consequently, the rent can be reduced, the usage of the plant and the warehouse can be enhanced, the industrial value can be enhanced, and the economic effectiveness can be satisfied.

To achieve the above-identified objects and effect, the invention provides a hinge device of a foldable chair. The foldable chair includes a front tube, a middle tube, a rear tube and a foot stand. Three-way hinges each including a first pivoting portion, a second pivoting portion and a third pivoting portion connect the front tube, the middle tube, the rear tube and the foot stand together. The characteristic lies in that the third pivoting portion is shifted from a straight line connecting the first pivoting portion to the second pivoting portion so that the third pivoting portion and the first and second pivoting portions are disposed alternately and all the pivoting portions after being folded form a right-angle arranged pattern. The foot stand is folded on an inner side of the middle tube and arranged in parallel to inner and outer portions of the middle tube. Thus, the volume and the thickness of the folded foldable chair can be reduced more effectively as compared with the prior art.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exploded view showing a conventional foldable chair hinge.

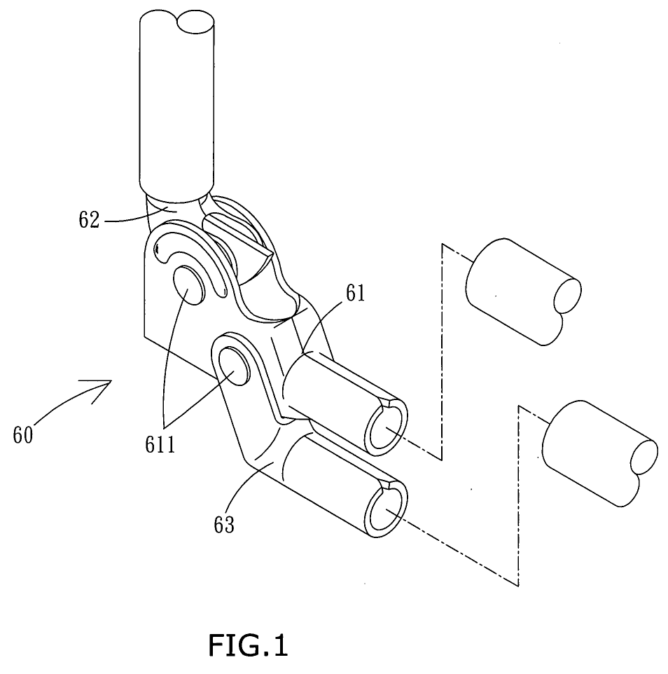

FIG. 2 is an assembled view showing the conventional foldable chair hinge.

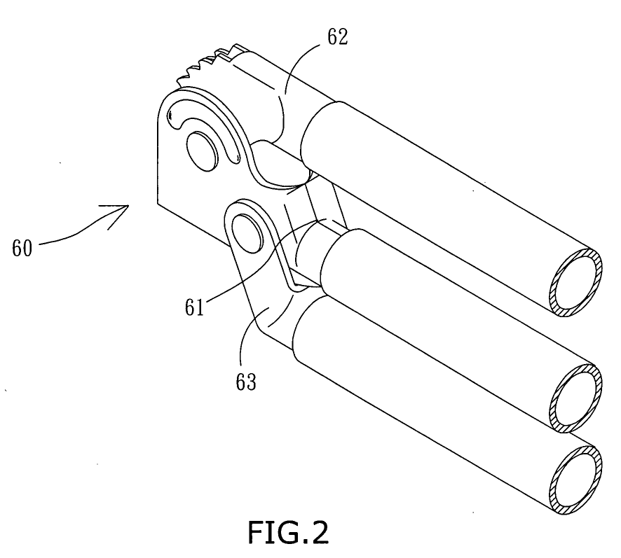

FIG. 3 shows a spread exterior of a foldable chair according to a preferred embodiment of the invention.

FIG. 4 partially shows a hinge of the foldable chair according to the preferred embodiment of the invention.

FIG. 5 is an exploded view showing the hinge of the foldable chair according to the preferred embodiment of the invention.

FIG. 6 is a schematic illustration showing the partially spread hinge of the foldable chair according to the preferred embodiment of the invention.

FIG. 7 is a schematic illustration showing the folded hinge of the foldable chair according to the preferred embodiment of the invention.

FIG. 8 is a plane view showing the completely folded foldable chair according to the preferred embodiment of the invention.

### DETAILED DESCRIPTION OF THE PREFERRED EMBODIMENTS

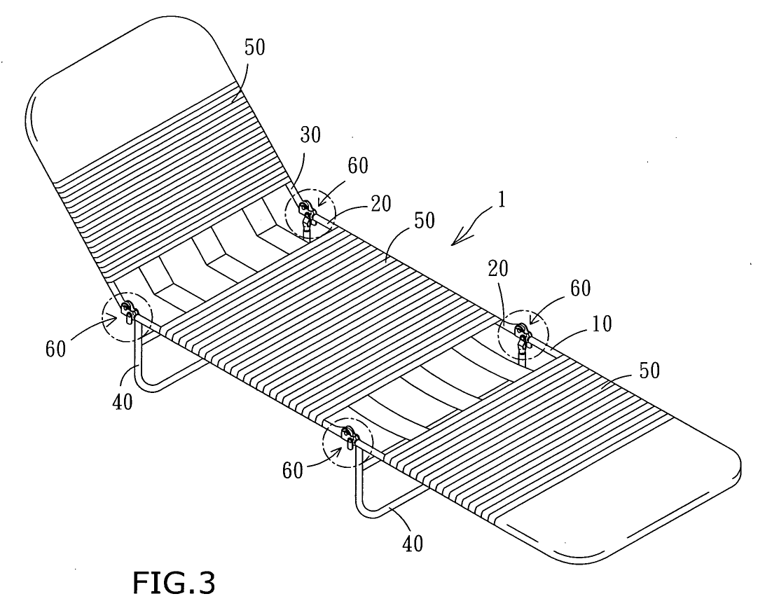

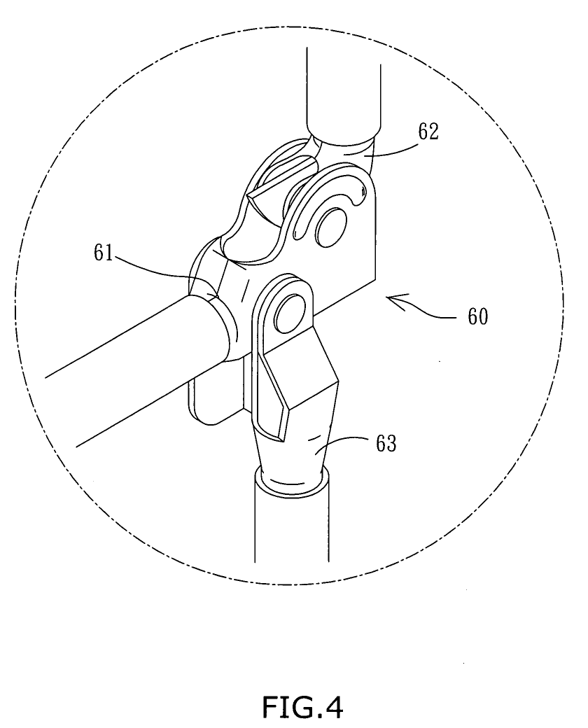

FIG. 3 shows a spread exterior of a foldable chair according to a preferred embodiment of the invention. Referring to FIG. 3, the foldable chair 1 includes a front tube 10, a middle tube 20, a rear tube 30 and foot stands 40. Cloth bodies 50 cover areas enclosed by the front tube 10, the middle tube 20 and the rear tube 30. Also, three-way hinges 60 (see FIG. 4) connect the front tube 10, the middle tube 20 and the foot stand 40 together and the middle tube 20, the rear tube 30 and the foot stand 40 together in the foldable chair 1. Each three-way hinge 60 is composed of a first pivoting portion 61, a second pivoting portion 62 and a third pivoting portion 63. Thus, all the tubes are combined to form the complete foldable chair 1, and the front tube 10, the rear tube 30 and the foot stand 40 can be folded in a direction toward the middle tube 20 or can be spread out in a reverse direction.

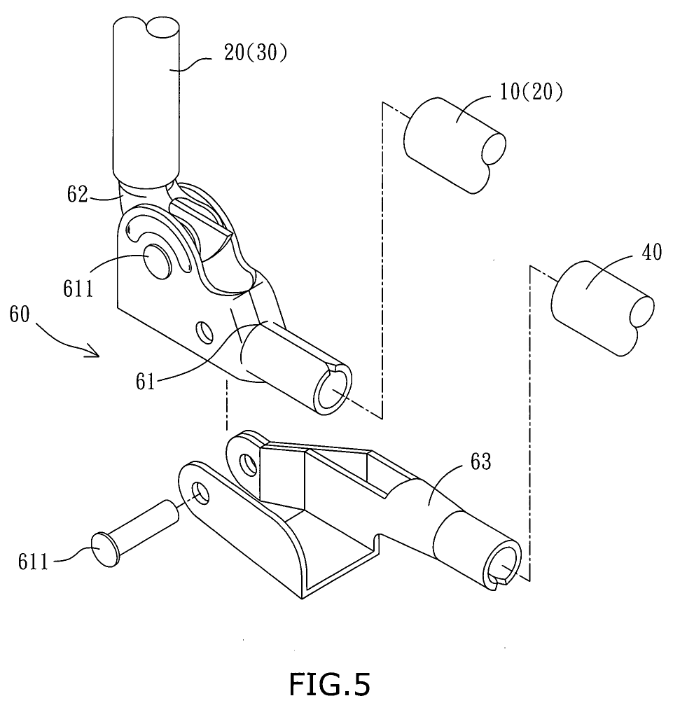

FIG. 5 is an exploded view showing the hinge of the foldable chair according to the preferred embodiment of the invention. As shown in FIG. 5, the hinge 60 includes the first pivoting portion 61, the second pivoting portion 62 and the third pivoting portion 63. The first pivoting portion 61 is combined and positioned with the second pivoting portion 62 and the third pivoting portion 63 through pins 611 so that all the pivoting portions are freely movable after being pivoted on the front tube 10, the middle tube 20, the rear tube 30 and the foot stands 40. More particularly, the third pivoting portion 63 is shifted from a straight line connecting the first pivoting portion 61 to the second pivoting portion 62 so that the third pivoting portion 63, the first pivoting portion 61 and the second pivoting portion 62 are disposed alternately, and all the pivoting portions after being folded form a right-angle arranged pattern but not a straight-line arranged pattern.

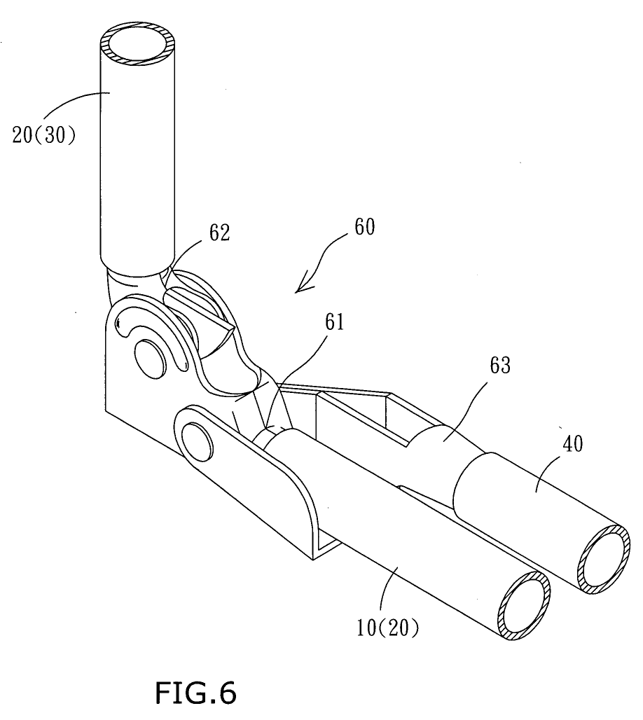

FIG. 6 is a schematic illustration showing the partially spread hinge of the foldable chair according to the preferred embodiment of the invention. As shown in FIG. 6, the first and second pivoting portions 61 and 62 of the hinge 60 provide the pivotal connection to the front tube 10, the middle tube 20 or the rear tube 30, and the third pivoting portion 63 provides the pivotal connection to the foot stand 40 so that the front tube 10, the rear tube 30 and the foot stand 40 can be freely spread out.

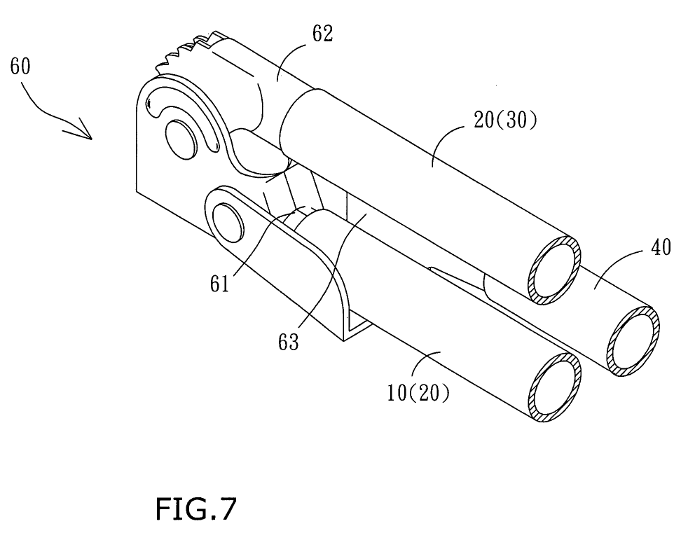

FIG. 7 is a schematic illustration showing the folded hinge of the foldable chair according to the preferred embodiment of the invention. As shown in FIG. 7, when the pivoting portions of the hinge 60 are being folded, the second pivoting portion 62 and the third pivoting portion 63 are folded toward the first pivoting portion 61, and the first to third pivoting portions 61, 62 and 63 of the folded hinge 60 form the right-angle arranged pattern in a cross-sectional view.

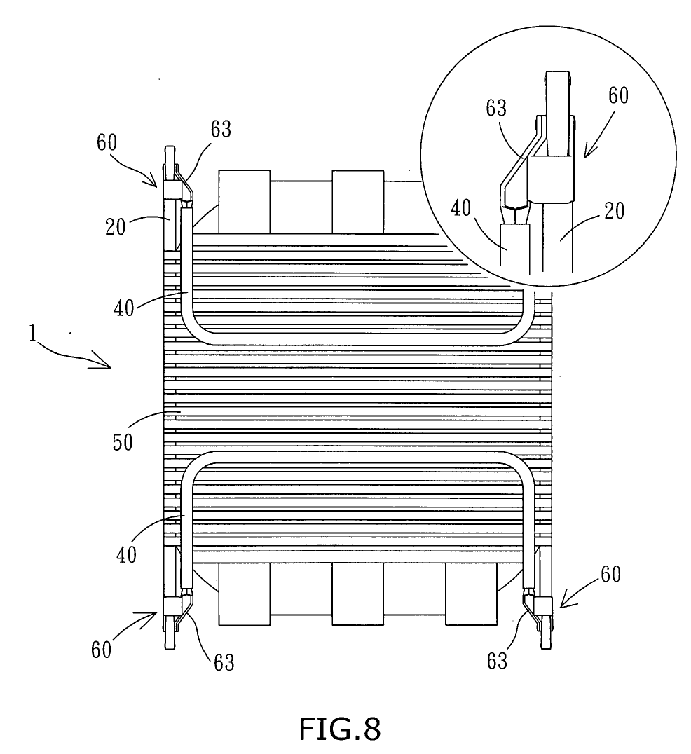

FIG. 8 is a plane view showing the completely folded foldable chair according to the preferred embodiment of the invention. As shown in FIG. 8, when the foldable chair 1 is being folded, the portion of the front tube 10 and the portion of the rear tube 30 are folded toward one surface of the portion of the middle tube 20, and the foot stands 40 are folded toward the other surface of the portion of the middle tube 20. Thus, when the folding is completed, the front and rear tubes 10 and 30 are perpendicular to the middle tube 20 while the foot stands 40 are folded toward the inner side of the middle tube 20 and are arranged in parallel to the inner and outer portions of the middle tube 20. According to this design, the thickness of the folded foldable chair 1 can be reduced so that the folded chair 1 can be placed conveniently without occupying too much space as compared with the prior art. More particularly, more foldable chairs can be placed in the same space for the manufacturer when the chairs are being transported and placed in the warehouse, or the same number of chairs can be placed but more redundant space that can be used may be obtained. Thus, the rent can be reduced, the usage of the plant and the warehouse can be enhanced, the industrial value can be enhanced, and the economic effectiveness can be satisfied.

In summary, the hinge device of the foldable chair according to the invention has the industrial value and the better inventive step and can achieve the object of the invention.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

1. (canceled)

2. A hinge device for a folding chair having a front tube, a middle tube, a rear tube, and a foot stand, the hinge device comprising:
a) a first pivoting portion;
b) a second pivoting portion pivotally connected to the first pivoting portion; and
c) a third pivoting portion, the second pivoting portion is pivotally connected to the first pivoting portion and the first pivoting portion is pivotally connected to a first end of the third pivoting portion.

3. The hinge device according to claim 2, wherein a second end of the third pivoting portion is offset from the first end of the third pivoting portion and is pivotal in a first plane, the first pivoting portion and the second pivoting portion are pivotal in a second plane parallel to the first plane.

4. The hinge device according to claim 2, wherein an end of the foot stand is connected to the third pivoting portion

5. The hinge device according to claim 2, wherein an end of the front tube is connected to the first pivoting portion and an end of the middle tube is connected to the second pivoting portion.

6. The hinge device according to claim 2, wherein an end of the middle tube is connected to the first pivoting portion and an end of the rear tube is connected to the second pivoting portion.
